(19) United States
(12) Patent Application Publication
(10) Pub. No.: US 2011/0066815 A1
(43) Pub. Date: Mar. 17, 2011

(54) MEMORY ACCESS CONTROL DEVICE AND MEMORY ACCESS CONTROL METHOD

(75) Inventors: Toru MATSUZAWA, Kunitachi-shi (JP); Aya NAKASHIMA, Hachioji-shi (JP)

(73) Assignee: OLYMPUS CORPORATION, Tokyo (JP)

(21) Appl. No.: 12/853,693

(22) Filed: Aug. 10, 2010

(30) Foreign Application Priority Data
Sep. 15, 2009 (JP) 2009-213629

(51) Int. Cl. G06F 12/00

(52) U.S. Cl. 711/154; 711/E12.001

(57) ABSTRACT

A memory access control device includes an input data control unit, a processing unit, and an output data control unit. The input data control unit inputs image data from a memory. The processing unit subjects the input image data to a preset process. The output data control unit outputs the processed image data to the memory.

### CROSS-REFERENCE TO RELATED APPLICATIONS

This application is based upon and claims the benefit of priority from the prior Japanese Patent Application No. 2009-213629, filed Sep. 15, 2009, the entire contents of which are incorporated herein by reference.

### BACKGROUND OF THE INVENTION

1. Field of the Invention

This invention relates to a memory access control device and memory access control method that control input/output of large-capacity data with respect to a memory.

2. Description of the Related Art

A direct memory access (DMA) system that performs data transfer between an input/output device and a system memory is known as one method for efficiently transferring data from the input/output device. The DMA system requires exclusive hardware that is generally called a data transfer control device, DMA controller or the like. Further, the DMA system is excellent in data transfer efficiency since it can perform direct data transfer between an input/output device and a system memory. In addition, since the DMA system can perform the data transfer process without using a CPU, the load of the CPU can be alleviated. As a result, the processing speed of the whole system can be increased.

If a data transfer control device is connected to a plurality of buses, it is necessary to use a bus bridge that includes a plurality of bus interface circuits as shown in Jpn. Pat Appln. KOKAI Publication No. H11-134289, for example. In Jpn. Pat Appln. KOKAI Publication No. H11-134289, it is disclosed that a data transfer control device can be connected to a plurality of buses by providing a relay device in the data transfer control device. Further, the technique for making it possible to continuously transfer data by providing a data storage unit in the relay device is proposed in Jpn. Pat Appln. KOKAI Publication No. 2004-355041.

For example, the above DMA system is used in an image processing apparatus such as a digital camera or the like. In the digital camera, a system memory is provided in the image processor and a large-capacity memory such as a DRAM is arranged outside the image processor. With this configuration, image data stored in the large-capacity memory is sequentially processed while the data is accumulated in the system memory of the image processor. After termination of the image process, processed data is output by being stored in the large-capacity memory or transferred to a peripheral device of the digital camera.

### BRIEF SUMMARY OF THE INVENTION

According to an aspect of the invention, there is provided a memory access control device comprising: an input data control unit configured to input image data from a memory; a processing unit configured to subject the input image data to a preset process; and an output data control unit configured to output the processed image data to the memory.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the configuration of an example of an image processing apparatus including a memory access control device according to an embodiment of this invention;

FIG. 2 is a diagram showing the pixel arrangement of Bayer image data;

FIG. 3 is a diagram showing the detailed configuration of the memory access control device;

FIGS. 4A and 4B are diagrams showing image data stored in a data storage unit at the time of a binning process;

FIGS. 5A, 5B, 5C and 5D are diagrams showing the states of identification of image data items at the time of the binning process;

FIGS. 6A and 6B are diagrams showing output states of a calculation unit at the time of the binning process;

FIG. 7 is a diagram showing image data obtained after the binning process;

FIGS. 8A and 8B are diagrams showing image data stored in a data storage unit at the time of a simplified luminance image generation process;

FIGS. 9A, 9B, 9C and 9D are diagrams showing the results of identification of image data items at the time of the simplified luminance image generation process;

FIGS. 10A and 10B are diagrams showing output states of a calculation unit at the time of the simplified luminance image generation process; and

FIG. 11 is a diagram showing image data obtained after the simplified luminance image generation process.

### DETAILED DESCRIPTION OF THE INVENTION

An embodiment of the invention will be described with reference to the accompanying drawings.

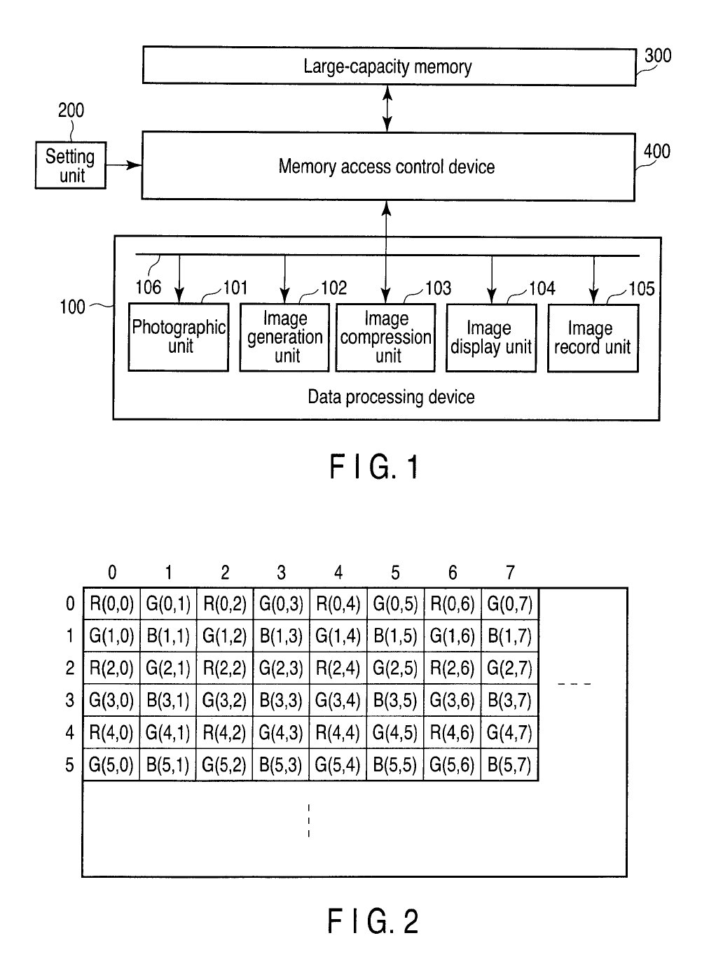

FIG. 1 is a diagram showing the configuration of an example of an image processing apparatus including a memory access control device according to an embodiment of this invention. FIG. 1 shows a digital camera as an example of the image processing apparatus. The digital camera shown in FIG. 1 includes a data processing device 100, setting unit 200, large-capacity memory 300 and memory access control device 400. Respective units included in the data processing device 100 are connected to the memory access control device 400 via an interconnect bus 106. The memory access control device 400 is connected to the large-capacity memory 300.

In FIG. 1, the data processing device 100 includes a photographic unit 101, image generation unit 102, image compression unit 103, image display unit 104 and image record unit 105. Each of the photographic unit 101, image generation unit 102, image compression unit 103, image display unit 104 and image record unit 105 includes one or more input/output interfaces and is configured to perform data transfer with units other than the large-capacity memory 300.

The photographic unit 101 photographs a subject and fetches an image of the subject obtained by photographing as digital image data. The image data fetched by the photographic unit 101 is transferred to the memory access control device 400 via the interconnect bus 106. The image data is stored in the large-capacity memory 300 under the control of the memory access control device 400. In this embodiment, it is supposed that image data obtained in the photographic unit 101 is Bayer image data. Bayer image data is image data obtained by alternately arranging rows of red (R) data and green (G) data and rows of green (G) data and blue (B) data. FIG. 2 shows the pixel arrangement of Bayer image data.

The image generation unit 102 receives image data read from the large-capacity memory 300 via the interconnect bus 106 and processed in the memory access control device 400. Further, the image generation unit 102 processes the received image data. The image data processed in the image generation unit 102 is input to the memory access control device 400 via the interconnect bus 106. The image data is stored in the large-capacity memory 300 under the control of the memory access control device 400.

The image compression unit 103 compresses image data processed in the image generation unit 102 and stored in the large-capacity memory 300 at the image data recording time. Further, the image compression unit 103 expands the compressed image data at the image data playback time.

The image display unit 104 displays an image based on image data generated from the image generation unit 102. The image record unit 105 stores image data compressed by the image compression unit 103.

The setting unit 200 is a processor, for example. The setting unit 200 outputs specified information to the memory access control device 400. In this case, the specified information is information used to set the format of image data input to the memory access control device 400 from the large-capacity memory 300 and the content of a data process executed by the memory access control device 400. As the format of image data, information indicating the image form such as YC422, information indicating the bit number and arrangement of respective image data items in image data of one frame, information indicating coordinate positions of respective image data items and the like are contained. For example, in the case of YC422, the data number ratio of luminance (Y) and color difference (Cb, Cr) is set to Y:Cr:Cb=4:2:2.

The memory access control device 400 relays input/output of data between the data processing device 100 and the large-capacity memory 300. Further, in this embodiment, the memory access control device 400 temporarily internally stores image data input from the data processing device 100 via the interconnect bus 106, subjects the stored image data to a preset process and then outputs the thus processed data to the large-capacity memory 300. The preset process is a simple calculation process such as a four-rule arithmetic operation, a process for extracting the specified component of image data or a process obtained by combining the above processes.

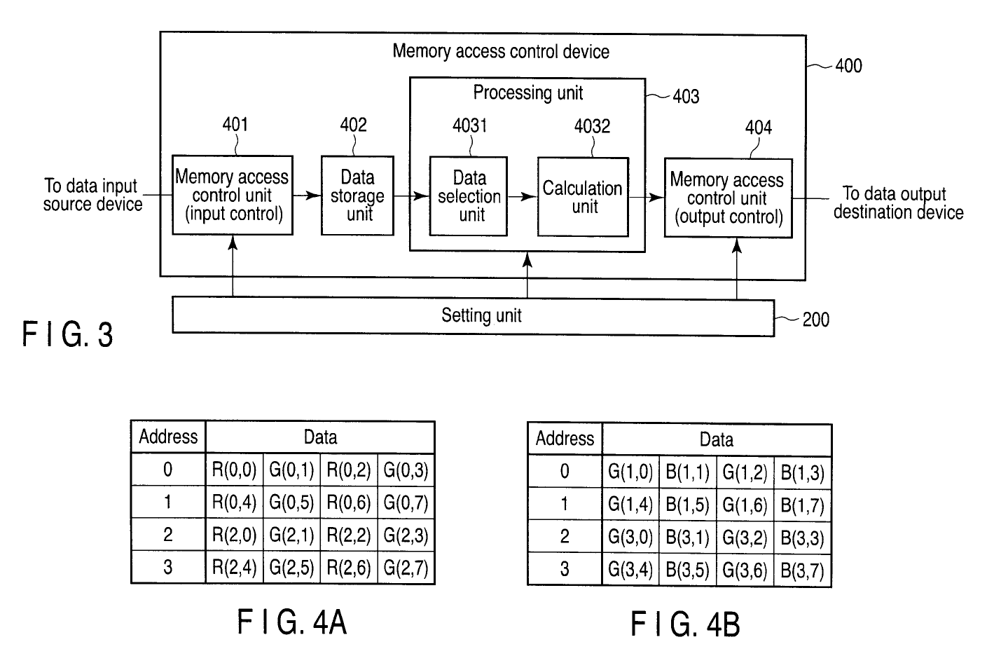

FIG. 3 is a diagram showing the detailed configuration of the memory access control device 400. As shown in FIG. 3, the memory access control device 400 includes a memory access control unit 401, data storage unit 402, processing unit 403 and memory access control unit 404. As shown in FIG. 3, the memory access control device 400 includes two memory access control units including the memory access control unit 401 for data reading and the memory access control unit 404 for data writing. The two memory access control units are each connected to the large-capacity memory 300 and interconnect bus 106.

The memory access control unit 401 having a function as an input data control unit receives data input thereto for each preset read unit from a data input source device in response to a memory access instruction from the setting unit 200. In a case where data is written into the large-capacity memory 300 from the data processing device 100, the data processing device 100 is used as the data input source device. On the other hand, in a case where data is read from the large-capacity memory 300 to the data processing device 100, the large-capacity memory 300 is used as the data input source device.

The data storage unit 402 stores image data received by the memory access control unit 401. In this case, the data storage unit 402 in this embodiment is configured by a single or a plurality of FIFO memories and has memory capacity capable of storing a plurality of image data items for each read unit transferred from the memory access control unit 401.

The processing unit 403 subjects data items stored in the data storage unit 402 to a preset process corresponding to an instruction from the setting unit 200. The processing unit 403 includes a data selection unit 4031 and calculation unit 4032. The data selection unit 4031 performs an identification process to select data items that are to be subjected to a preset process among a plurality of data items of each read unit stored in the data storage unit 402. The calculation unit 4032 performs a calculation corresponding to the content of a preset process with respect to data items selected by means of the data selection unit 4031. In this case, it is supposed that the calculation unit 4032 is configured by a combination of general-purpose calculation units for the four-rule arithmetic operation or the like.

As described above, the processing unit 403 has a configuration to select a plurality of input data items. Therefore, it is desirable for the data storage unit 402 to simultaneously refer to the plurality of data items. With this configuration, the transfer latency at the data selection time can be suppressed.

The memory access control unit 404 having a function as an output data control unit outputs data to a data output destination device for each preset write unit in response to a memory access instruction from the setting unit 200. In a case where data is written into the large-capacity memory 300 from the data processing device 100, the large-capacity memory 300 is used as the data output destination device. On the other hand, in a case where data is read from the large-capacity memory 300 to the data processing device 100, the data processing device 100 is used as the data output destination device.

Next, the operation of the memory access control device 400 of this embodiment is explained. As described before, in this embodiment, the memory access control device 400 is not only operated to perform the memory access control operation but also operated to perform the simplified process with respect to image data.

First, an example in which a mixing process (that is hereinafter referred to as a binning process) for a plurality of components of the same colors in Bayer image data obtained by the photographic unit 101 is performed is explained. The size of an image data is reduced by performing the binning process.

First, the setting process at the image data read time is explained. Prior to the image data read process, the setting unit 200 sets specified information to specify a preset process with respect to the memory access control device 400 by taking the width of the data bus and the number of pixels required for the data process into consideration. The specified information specifies a memory access method, image format and a process to be performed.

In the following explanation, it is supposed that image data that can be acquired by one data input process by means of the memory access control unit 401 has four pixels and the data storage unit 402 can store 16 image data items of 4 pixels×4. In this case, the setting unit 200 issues an instruction to the memory access control unit 401 to separately acquire even and odd rows of image data items of one frame at the image data read time. Further, the setting unit 200 instructs the memory access control unit 401 to set the image format into Bayer 2×2 (four pixels of RGGB are set as one unit) and set the arrangement of respective image data items in the data bus. Further, the setting unit 200 instructs the processing unit 403 to set a process to be performed to a binning process.

By making the above setting, as shown in FIGS. 4A and 4B, image data items of only odd rows and image data items of only even rows can be stored in the data storage unit 402. In FIGS. 4A and 4B, data items of an eighth column and the succeeding columns in FIG. 2 are not shown in the drawing.

In this case, it is considered that the memory access control unit 401 does not have a function of separately acquiring image data items of even rows and image data items of odd rows. In such a case, the memory access control unit 401 may acquire image data items of each unit as one block and then select image data items of even rows and odd rows. That is, if image data items are stored in the form shown in FIGS. 4A and 4B in the data storage unit 402, setting with respect to the memory access control unit 401 is not limited to the above setting.

Next, a sequential flow of processes after the image data read process is started is explained. After the image data read process is started, the memory access control unit 401 acquires image data from the photographic unit 101 used as a data input source device via the interconnect bus 106 and stores the thus acquired image data in the form shown in FIGS. 4A and 4B in the data storage unit 402. If image data items which the memory access control unit 404 can output is stored in the data storage unit 402, the memory access control unit 404 starts an image data output process of outputting image data output from the processing unit 403 to a data output destination device (large-capacity memory 300).

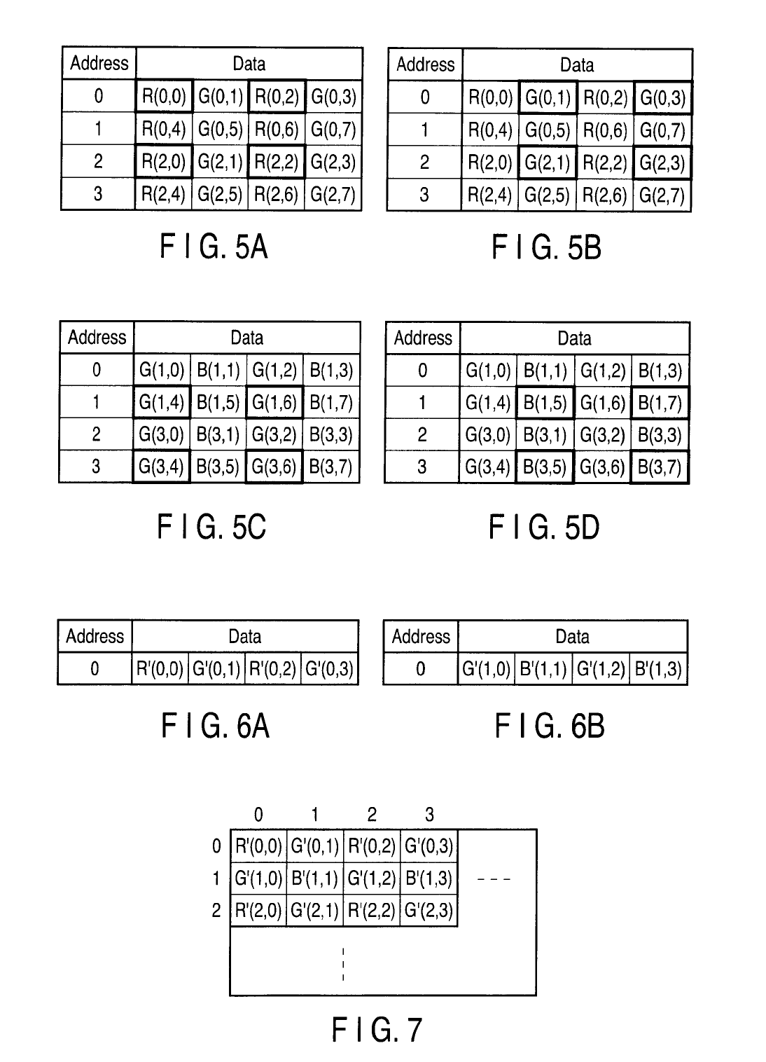

The data selection unit 4031 in the processing unit 403 reads image data items stored in the data storage unit 402 and identifies the positions of the thus read image data items, for example, as shown in FIGS. 5A to 5D in parallel with the image data output process of the memory access control unit 404. That is, the positions of the same color components in the image data of each read unit are identified. The data selection unit 4031 identifies the positions of the green components in the case of a Bayer image data for respective image data items of even rows and image data items of odd rows as shown in FIGS. 5B and 5C.

After the positions of image data items are identified in the data selection unit 4031, the calculation unit 4032 reads image data items stored in the data storage unit 402 and adds the thus read image data items to realize the binning process. In this case, the addition equations in the binning process are indicated as follows.

R′(m,n)=(R(2m,2n)+R(2m,2(n+1))+R(2(m+1),2n)+R(2(m+1),2(n+1)))/4

G′(m,n)=(G(2m,2n)+G(2m,2(n+1))+R(2(m+1),2n)+G(2(m+1),2(n+1)))/4

B′(m,n)=(B(2m,2n)+B(2m,2(n+1))+B(2(m+1),2n)+B(2(m+1),2(n+1)))/4

In the above equations, m, n are parameters indicating the pixel positions. The arrangements of R′(m, n), G′(m, n), B′(m, n) correspond to the arrangement of the Bayer image shown in FIG. 2. If a case of FIG. 5A is taken as an example, four terms of R(0, 0), R(0, 2) stored in address 0 and R(2, 0), R(2, 2) stored in address 2 are added together and then ¼ is multiplied in the calculation unit 4032. As a result, new image data item R′(0, 0) is obtained.

As the result of the binning process for image data stored in the data storage unit 402 as shown in FIG. 4A, image data shown in FIG. 6A is obtained. Further, as the result of the binning process for image data stored in the data storage unit 402 as shown in FIG. 4B, image data shown in FIG. 6B is obtained. The calculation unit 4032 outputs the thus obtained execution results to the memory access control unit 404.

By continuously performing a sequence of the above processes for image data of one frame, image data obtained after the binning process as shown in FIG. 7 is output to the large-capacity memory 300 used as a data output destination device.

Next, an example in which a process of simply generating a luminance image based on Bayer image data obtained by means of the photographic unit 101 is performed is explained. For example, the luminance image is used when an image of a face position of a subject in the image obtained by means of the photographic unit 101 is detected.

In the following explanation, an example in which a luminance image of one pixel is derived based on four pixels including two pixels in the vertical direction and two pixels in the lateral direction is explained. The size of a luminance image data obtained in this case becomes ¼ the size of the original Bayer image data.

First, the explanation for setting at the image data read time is made. Prior to the image data read process, the setting process 200 sets a memory access method, image format and a process to be performed with respect to the memory access control device 400 by taking the width of the data bus and the number of pixels required for the data process into consideration.

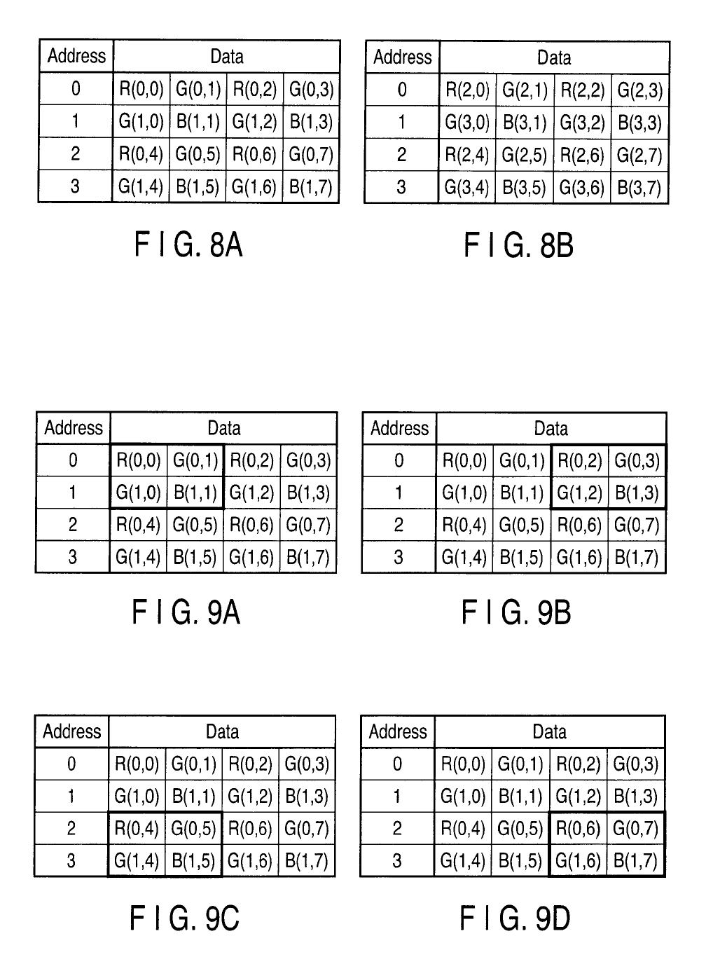

For example, if it is supposed that image data that can be acquired by one data input operation by means of the memory access control unit 401 is four pixels and the data storage unit 402 can store 16 image data items of 4 pixels×4, the setting unit 200 issues an instruction to the memory access control unit 401 to acquire image data of one frame for every two rows at the image data read time. Further, the setting unit 200 instructs the memory access control unit 401 to set the image format to Bayer 2×2 and set the arrangement of respective image data items in the data bus. Additionally, the setting unit 200 instructs the processing unit 403 to set a process to be performed to a simplified luminance image generation process. As a result, image data items of R, G and image data items of G, B are alternately stored in the data storage unit 402 as shown in FIGS. 8A and 8B.

If available capacity is present in the data storage unit 402, the memory access control unit 401 may acquire image data items for each unit in a block form and then select image data items of every two rows later. That is, if image data items are stored in a form shown in FIGS. 8A and 8B in the data storage unit 402, setting with respect to the memory access control unit 401 is not limited to the above setting.

Next, the flow of a sequence of processes after starting the image data read process is explained. After starting the image data read process, the memory access control unit 401 acquires image data from the photographic unit 101 used as a data input source device via the interconnect bus 106 and stores the thus acquired image data in the data storage unit 402 in the form of FIGS. 8A and 8B. If image data of an amount that can be output from the memory access control unit 404 is stored in the data storage unit 402, the memory access control unit 404 starts a process of outputting image data to the large-capacity memory 300 used as a data output destination device of image data output from the processing unit 403.

The data selection unit 4031 of the processing unit 403 reads image data items stored in the data storage unit 402 and identifies the positions of to-be-added image data items in the thus read image data items, for example, as shown in FIGS. 9A to 9D in parallel with the image data output process of the memory access control unit 404. That is, the data selection unit 4031 identifies the pixel positions of every two pixels in the vertical direction and every two pixels in the lateral direction from the upper left end in the image data of each read unit.

After the positions of image data items are identified in the data selection unit 4031, the operational unit 4032 reads image data items stored in the data storage unit 402 and adds the thus read image data items to realize the simplified luminance image generation process. In this case, the addition equation in the simplified luminance image generation process is indicated as follows. In the following equation, m, n are parameters indicating the pixel positions.

Y′(m,n)=(R(2m,2n)+G(2m,2n+1)+G(2m+1,2n)+B(2m+1,2n+1))/4

If a case of FIG. 9A is taken as an example, four terms of R(0, 0), G(0, 1) stored in address 0 and G(1, 0), B(1, 1) stored in address 1 are added together and then ¼ is multiplied in the calculation unit 4032. As a result, luminance image data item Y′(0, 0) is obtained. In practice, it is necessary to multiply preset coefficients for respective color components to generate actual luminance images, but in this example, a common coefficient of ¼ is multiplied.

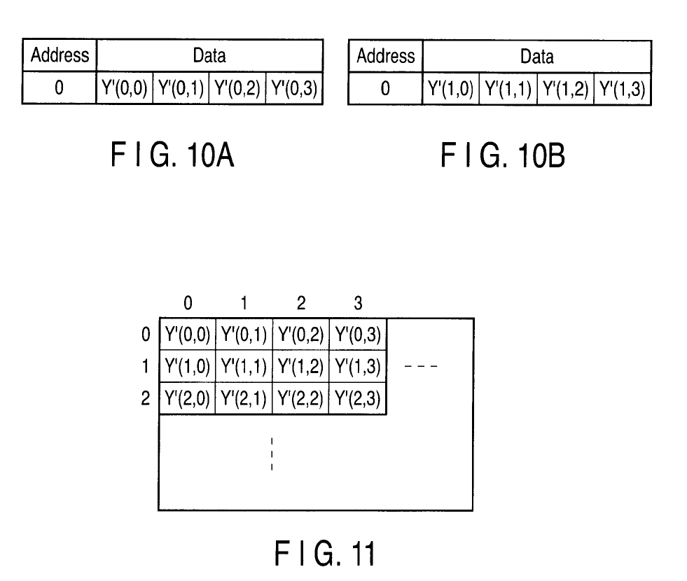

As the result of the simplified luminance image generation process for image data stored in the data storage unit 402 as shown in FIG. 8A, luminance image data shown in FIG. 10A is obtained. Further, as the result of the simplified luminance image generation process for image data stored in the data storage unit 402 as shown in FIG. 8B, luminance image data shown in FIG. 10B is obtained. The calculation unit 4032 outputs the thus obtained execution results to the memory access control unit 404.

By continuously performing a sequence of the above processes for image data of one frame, luminance image data as shown in FIG. 11 is output to the large-capacity memory 300 used as a data output destination device.

Thus, in this embodiment, the binning process and simplified luminance image generation process can be performed simply by performing a simple data process in the memory access control device. Each of the binning process and simplified luminance image generation process shown in the above examples can be realized by extracting data items of four terms required for the binning process and luminance image generation process from the Bayer image data and adding the thus extracted data items of four terms. Therefore, the calculation unit 4032 can be configured by an adder that adds data items of four terms identified by the data selection unit 4031 and a multiplier that multiplies the output of the adder by ¼. By thus dividing the image processing function, an attempt can be made to commonly use operation resources even if they have apparently different functions.

As described above, according to this embodiment, when image data is written from the data processing device 100 side to the large-capacity memory 300 via the memory access control device 400, the image data is subjected to the binning process or simplified luminance image generation process in the memory access control device 400. As a result, since the data size of image data to be written in the large-capacity memory 300 is reduced, the storage amount used in the large-capacity memory 300 can be reduced.

In this embodiment, data is selected from the data storage unit 402 to realize a preset data process by combining general-purpose processes in the memory access control device 400 at the memory access time. As a result, the data process that is frequently performed in the image processing apparatus (digital camera) can be generalized to commonly use operation resources.

Further, by performing a process in the memory access control device 400, data can be output to the data output destination device without degrading the processing performance of the whole system. Since it becomes unnecessary to perform a part of the processes in the respective units of the data processing device 100, the effect that the load of the data processes in the respective units of the data processing device 100 can be alleviated is attained.

In the above example, a case wherein the data processing device 100 is used as the data input source device and the large-capacity memory 300 is used as the data output destination device is explained. However, the large-capacity memory 300 can be used as the data input source device and data output destination device. That is, in the above example, a process is performed when image data acquired by the photographic unit 101 is stored in the large-capacity memory 300, but it is possible to perform the process after image data acquired by the photographic unit 101 is stored in the large-capacity memory 300.

Further, it is possible to use the large-capacity memory 300 as the data input source device and use the data processing device 100 as the data output destination device. With this configuration, the load of the interconnect bus 106 when image data is input from the large-capacity memory 300 to the data processing device 100 via the memory access control device 400 can be alleviated.

Further, in the above embodiment, the binning process and simplified luminance image generation process using an adding process as an example of the data process performed in the memory access control device are shown as an example. However, various space filtering processes can be performed in the memory access control device by adequately combining the four-rule arithmetic operations (in practice, a subtraction process can be replaced by an adding process and a division process can be replaced by a multiplication process). For example, a process of extracting only specified data such as only luminance data or only specified color can be performed by utilizing the space filtering process.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory access control device comprising:
an input data control unit configured to input image data from a memory;
a processing unit configured to subject the input image data to a preset process; and
an output data control unit configured to output the processed image data to the memory.

2. The memory access control device according to claim 1, wherein the processing unit includes a data selection unit configured to select image data items of specified pixel positions in the input image data based on specified information used to specify the preset process; and a calculation unit configured to perform a calculation corresponding to the preset process with respect to the selected image data items based on the specified information.

3. The memory access control device according to claim 2, wherein the preset process includes a process of reducing a data size of the selected image data items.

4. The memory access control device according to claim 3, wherein the process of reducing the data size of the selected image data items includes (i) a four-rule arithmetic operation for the selected image data items, (ii) a process of extracting an image data item of a specified component among the selected image data items and (iii) a combination of the four-rule arithmetic operation and the process of extracting.

5. The memory access control device according to claim 1, further comprising a setting unit configured to set a content of the preset process.

6. A memory access control method comprising:
inputting image data from a memory;
subjecting the input image data to a preset process; and
outputting the processed image data to the memory.
